(19) United States
(12) Patent Application Publication
(10) Pub. No.: US 2008/0029172 A1
(43) Pub. Date: Feb. 7, 2008

(54) INTEGRATED PRESSURE PROOF FLUID CONTAINER WITH FLEXIBLE PIPE CONNECTORS

(76) Inventor: Paul A. Willems, Leiden (NL)

Correspondence Address: SABIC - 08CT;SABIC Innovative Plastics - IP Legal, ONE PLASTICS AVENUE, PITTSFIELD, MA, 01201-3697, US

(21) Appl. No.: 11/682,896

(22) Filed: Mar. 7, 2007

Related U.S. Application Data
(60) Provisional application No. 60/781,601, filed on Mar. 10, 2006.

(51) Int. Cl. F16L 35/00

(52) U.S. Cl. 137/800

(57) ABSTRACT

A fluid device that provides one or more features selected from being substantially tamper-resistant, substantially fluid-tight, and/or capable of providing stress relief to the various components used to form the fluid device. The fluid device accomplishes one or more of these features through the use of an injection material that is capable of substantially filling connection spaces in the fluid device using a low-pressure injection system. By using this injection material and a low-pressure injection system, the injection material may be injected into the connection spaces in the fluid device. Then, after the injection material has hardened, the injection material provides a mechanical barrier that provides the one or more benefits described.

### CROSS REFERENCE TO RELATED APPLICATIONS

The present application claims priority to U.S. Provisional Application No. 60/781,601, which was filed Mar. 10, 2006.

### FIELD OF INVENTION

The present invention relates to tamper-resistant devices and, in particular, tamper-resistant devices that may also be substantially fluid-tight.

### BACKGROUND OF INVENTION

Presently, many municipalities utilize utility meters to determine utility consumption. The meters, such as water meters, include a meter that identifies the consumption of the water consumed. The meter is read periodically and the difference between the present and the prior reading determines the amount of water consumed. The amount of water consumed is then used to determine the amount of money the consumer is to be charged. Since an individual's water bill is directly proportional to the amount of water consumed, there is an incentive for certain individuals to tamper with the water meter to alter the reading to lower the amount of their water bill.

As such, many water meters include designs that enable a determination to be made whether a meter has been tampered with since standard means for making the devices do not include tamper-resistant characteristics. Though the use snap-tight lids, screws, and/or press fit lids may be used to form the devices, they do not help reduce the risk of tampering. As such, in each prior art solution, the lid is still capable of being removed from the water meter, either through removal of the screws or forced opening of the snap-tight lid through a screwdriver or similar tool.

In addition, many fluid devices, such as water meters, suffer from issues wherein the devices leak. Again, due to the manner in which the devices are made, there are still openings and/or connection spaces between the various components. While prior art solutions have been attempted, these solutions, such as o-rings, washers and the like, suffer from the problem that many of these components are constructed from materials that breakdown over time. Accordingly, these components must be replaced periodically, leading to downtime and added maintenance expense.

Lastly, many devices that were previously constructed from metal materials are now being constructed from plastic materials. While plastic materials offer many advantages over metal materials, such as increased precision during manufacture of the device, lower cost, and/or greater degree of manufacturing design of the fluid devices, these plastic materials are, in many instances, more easily damaged due to excessive force.

### SUMMARY OF THE INVENTION

The present invention addresses the issues associated with the prior art by providing a fluid device that provides one or more features selected from tamper-resistant, substantially fluid-tight, and/or capable of providing stress relief to the various components used to form the fluid device. The present invention accomplishes one or more of these features through the use of an injection material that is capable of substantially filling connection spaces in the fluid device using a low-pressure injection system. By using this injection material and a low-pressure injection system, the injection material may be injected into the connection spaces in the fluid device. Then, after the injection material has hardened, the injection material provides a mechanical barrier that provides the one or more benefits described.

Accordingly, in one aspect, the present invention provides a fluid device including a housing, a lid attached to the housing, an inlet connector to the housing, and an outlet connector from the housing; wherein the fluid device includes at least one connection space between the housing and the lid, between the inlet connector and the housing, or between the outlet connector and the housing and wherein an injection material substantially fills at least one connection space between the housing and the lid, between the inlet connector and the housing, between the outlet connector and the housing, or a combination thereof.

In another aspect, the present invention provides a fluid device including a housing, an inlet connector to the housing, and an outlet connector from the housing; wherein the fluid device includes at least one connection space between the inlet connector and the housing or between the outlet connector and the housing and wherein an injection material substantially fills at least one connection space between the inlet connector and the housing or between the outlet connector and the housing or both.

In yet another aspect, the present invention provides a method of forming a fluid device including the steps of placing a fluid device into a low-pressure injection system wherein the fluid device comprises a housing, an inlet connector to the housing, and an outlet connector from the housing; wherein the fluid device includes at least one connection space between the inlet connector and the housing or between the outlet connector and the housing and injecting an injection material into at least one connection space between the inlet connector and the housing or between the outlet connector and the housing such that the injection material substantially fills at least one connection space between the inlet connector and the housing or between the outlet connector and the housing or both.

### BRIEF DESCRIPTION OF THE DRAWINGS

FIG. 1 is a perspective view of a water meter according to one embodiment of the present invention.

FIG. 2 is a cross-sectional view of a water meter according to one embodiment of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of” Furthermore, all ranges disclosed herein are inclusive of the endpoints and are independently combinable.

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases. In at least some instances, the approximating language may correspond to the precision of an instrument for measuring the value.

The present invention provides a fluid device and method of making the same wherein the fluid device provides one or more benefits compared to prior art devices. These benefits may include, but are not limited to, tamper-resistant, substantially fluid-tight, and/or having greater stress relief on one or more components of the fluid device.

The fluid device and method of making the same accomplishes one or more of these benefits through the use of an injection material that is injected into one or more connection spaces in the fluid device. As used herein, the term “connection space” refers to an opening or space between two or more components. For example, in those embodiments wherein a lid is attached to a housing, after the lid has been attached, there is normally a space between an inner portion of the lid and an outer portion of the housing. This space would be defined as a connection space in the present invention. In general, a “connection space” in a device is any opening or space between any two or more components that is not typically occupied by another material or element.

The injection material substantially fills the one or more connection spaces and then hardens. After the injection material hardens, the injection material provides a much greater contact between various components of the fluid device. Accordingly, for example, when the injection material is injected between the housing of a fluid device and the lid, the injection material forms a mechanical lock that substantially prevents the lid from being removed from the housing, such that the resulting fluid device is now more tamper-resistant.

In an alternative embodiment, the injection material may be injected in the connection spaces between those components through which the fluid passes. For example, many fluid devices include an inlet connector and an outlet connector. In those instances wherein the inlet connector and/or outlet connector are attached to the housing, connection spaces are created through which fluid can escape. By injecting the injection material in those connection spaces, once the injection material hardens, the fluid is substantially prevented from exiting the device except through the device outlet connector, thereby making the fluid device substantially fluid-tight.

In yet another alternative embodiment, the injection material may be injected into one or more connection spaces to help provide stress relief to the selected components, especially in those embodiments wherein the components are constructed from a plastic material, provided the injection material has a lower modulus than the materials of the components between which it is injected. This is particularly important at the connector parts wherein some freedom of movement is beneficial such that when the fluid device is assembled onto pipes that are not properly aligned, the stresses on those parts could result in cracking or crushing of these parts. By injecting the injection material into one or more connection spaces that will be under stress, the injection material may provide stress relief by permitting these parts to move slightly in response to the stress while maintaining the integrity of the device and/or maintaining a substantially fluid-tight seal.

Accordingly, the present invention utilizes an injection material that is capable of filling one or more connection spaces in a fluid device such that one or more of these aspects are provided in the final fluid device. Since the injection material is added after the fluid device has been formed, the injection material is selected such that injection of the injection material into the fluid device does not damage the fluid device.

In one embodiment, the injection material is injected using a low-pressure injection system. As used herein, “low-pressure” refers to an injection system that operates at a lower pressure than the device is capable of withstanding. For example, if the device is designed to withstand an operating pressure of 60 bars before failure, the pressure of the system that applies the injected material should not exceed this. As such, the pressure of the injection system may be determined by the design of the assembly and cost-wise this may be adjusted based on the device to be made. In alternative embodiments, if a higher-pressure resistance is needed for the injection of the injection material, the device can be designed to withstand this higher pressure such that the low-pressure injection system is still operating at a pressure lower than the final device is capable of withstanding. In this system, the fluid device is placed in the low-pressure injection system and the injection material is added. The low-pressure injector forces the injection material into the selected connection spaces in the fluid device, causing the injection material to enter into and fill or substantially fill the selected connection spaces. Then, after removal from the low-pressure injector, the injection material hardens, thereby forming a mechanical bond with the parts between which the injection material was injected. As previously mentioned, this mechanical bond helps to provide tamper-resistant and/or fluid-tight characteristics to the fluid device, depending on which connection spaces the injection material is injected into.

Therefore, the injection material used in the present invention is any material that is capable of being injected into and substantially filling connection spaces within a fluid device using a low-pressure injection system. Depending on the selected properties of the finished fluid device, the injection material may be a low modulus material or a high modulus material. Higher modulus materials may provide some additional benefits in regards to being more tamper-resistant and/or fluid-tight while lower modulus materials may provide some additional advantages in regards to stress relief. However, it is to be understood that any injection material capable of being injected into and substantially filling one or more connection spaces within a fluid device using a low-pressure injection system may provide one or more of these benefits. In general, the injection material is selected such that it can provide at least some sealing function, which may be variable based upon the fluid device requirements and such that it may be used in relatively low pressure processing to prevent collapse of the fluid device during injection of the injection material. Also, in some embodiments, it is beneficial for the injection material to be thermoplastic since the injection material may be hardened without the addition of heat that may damage other parts of the fluid device.

Examples of injection materials that may be used in the present invention include, but are not limited to, thermoplastic elastomers (TPE), thermoplastic urethanes (TPU), styrene-ethylene-butylene-styrene elastomers (SEBS), or a combination thereof. Silicone materials may also be used in those embodiments wherein the fluid device is capable of being subjected to heat since silicone materials may be hardened using heat. Nevertheless, for fluid devices constructed from plastic materials, the use of silicones is limited to the Heat Deflexion Temperature (HDT) of the plastic materials used to make the components in the device. For example, if the silicones need only 150° C. to cure and the HDT of the surrounding parts is 180° C., silicones may be used. However, if one or more components had, for example, an HDT of 120° C., it would melt during curing of the silicones such that alternative materials would be used for the injection material.

As discussed, the injection materials used in the present invention may be used with any fluid device. Nevertheless, in some embodiments, the fluid device is constructed from a plastic material, such as a thermoplastic material or a thermoset material. Examples of plastic materials that may be used to construct the fluid devices of the present invention include, but are not limited to, acrylonitrile-butadiene-styrene (ABS), polycarbonate (LEXAN® and LEXAN® EXL resins commercially available from General Electric Company), polycarbonate/ABS blend, a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide (NORYL® GTX® resins from General Electric Company), blends of polycarbonate/PET/PBT, polybutylene terephthalate and impact modifier (XENOY® resins commercially available from General Electric Company), polyamides, phenylene sulfide resins, polyvinyl chloride PVC, high impact polystyrene (HIPS), low/high density polyethylene, polypropylene and thermoplastic olefins (TPO), polyethylene and fiber composites, polypropylene and fiber composites such as AZDEL Superlite™ sheets commercially available from AZDEL, Inc., glass and/or carbon fiber reinforced resin materials, or a combination including one or more of these materials.

The fluid devices of the present invention may be constructed by injecting a non-liquid injection material into one or more connection spaces using a low-pressure injection system. As a result, depending on the size of the connection spaces, the type of injection material used, and/or the selected degree in which the connection spaces are filled, the fluid devices of the present invention may also include means for preventing the injection material from exiting the connection spaces before the injection material has hardened.

The foregoing and other features of the present invention will be more readily apparent from the following detailed description and drawings of the illustrative embodiments of the invention wherein like reference numbers refer to similar elements.

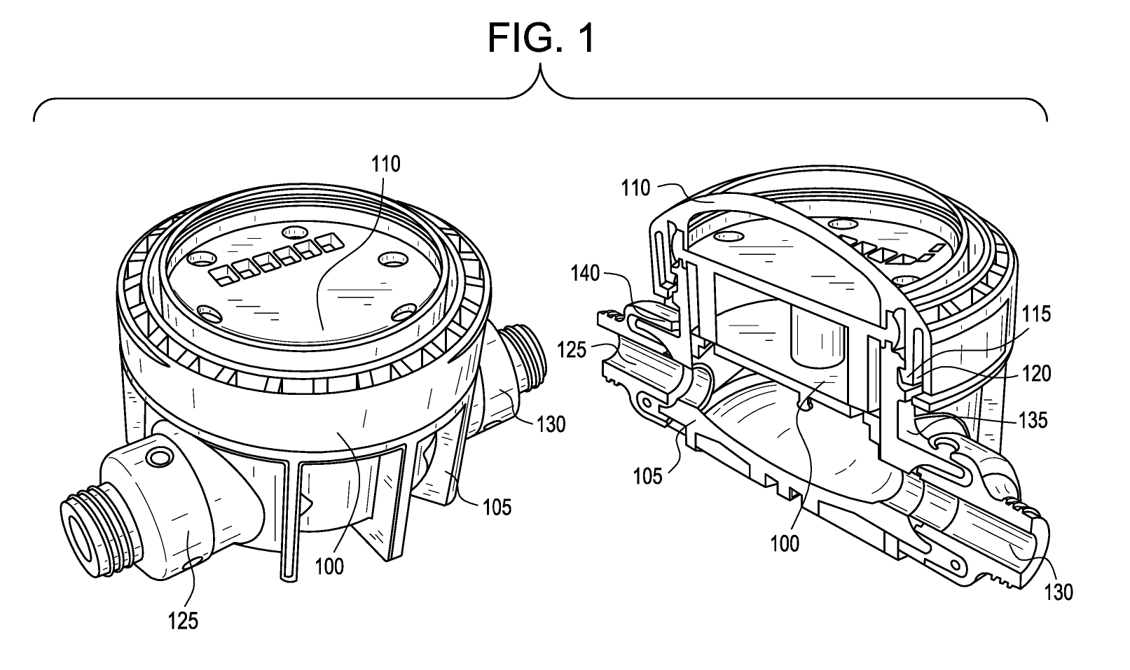

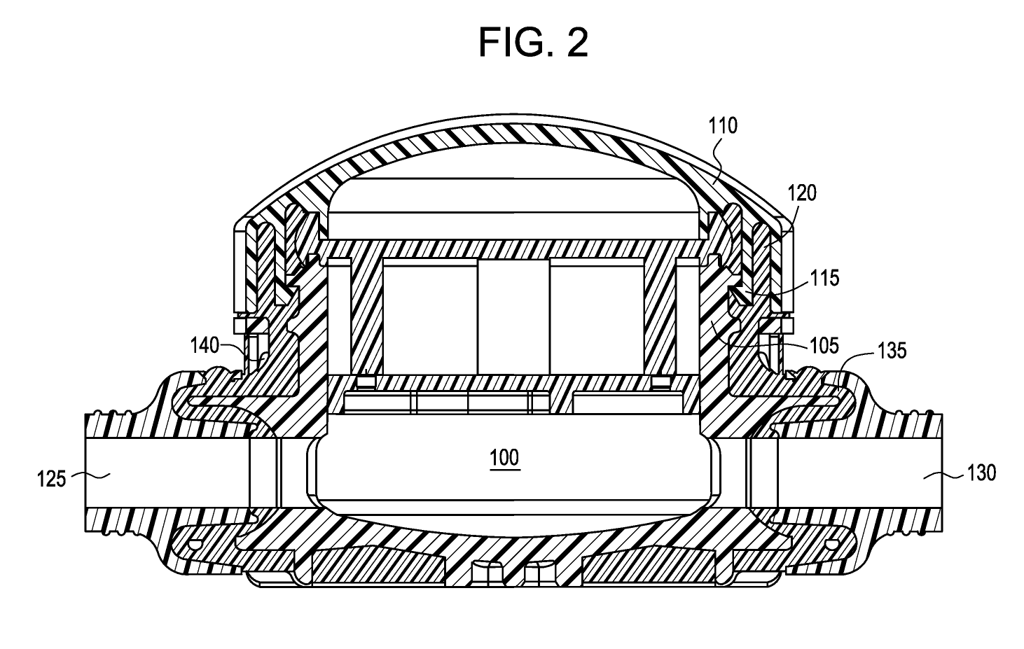

Referring to the drawings, FIGS. 1 and 2 provide one embodiment of a fluid device according to the concepts of the present invention. In these figures, a water meter 100 is shown. As seen in greater detail in FIG. 2, the water meter 100 includes a housing 105 and a lid 110 that is attached to the housing a snap-tight connector 115. As seen in FIG. 2, the attachment of the lid 110 to the housing 105 results in a connection space 120 between the housing 105 and the outer periphery of the lid 110.

The water meter 100 also includes an inlet connector 125 and an outlet connector 130. The inlet connector 125 and outlet connector 130 may be connected in any manner, but connection of the inlet connector 125 and/or the outlet connector 130 to the housing 105 results in one or more connection spaces 135, 140 between the inlet connector 125 and the housing 105 and between the outlet connector 130 and the housing.

As a result of these connection spaces 120, 135, 140, an injection material 145 is then injected into one or more of these connection spaces 120, 135, 140 using a low-pressure injection system to substantially fill one or more of these connection spaces 120, 135, 140. While FIGS. 1 and 2 show all three connection spaces 120, 135, 140 substantially filled with injection material 145, it is to be understood that in other embodiments, only one or two of connection spaces 120, 135, 140 may be filled with injection material 145.

Accordingly, as may be seen, the injection material 145 substantially fills one or more of connection spaces 120, 135, 140 such that water is substantially prevented from exiting the water meter 100 through any of connection spaces 120, 135, 140. Also, based on the injection material 145 used, after the injection material 145 has hardened in connection space 120, the injection material forms a mechanical lock such that lid 110 and housing 105 are rigidly connected thereby making water meter 100 substantially tamper-resistant. Lastly, depending on the injection material 145 used, the material 145, if a lower modulus material, may provide stress relief between inlet connector 125 and housing 105 and between outlet connector 130 and housing 105 when the injection material is located in connection spaces 135 and/or 140.

While these embodiments utilize a housing having a lid, it is to be understood that, in alternative embodiments, the housing may be a one-piece enclosed housing such that the injection material is injected into one of the connector spaces between the inlet and the housing and/or between the outlet and the housing.

It is also to be understood that while the specification and examples reference a water meter as the fluid device, the concepts of the present invention may be used in any fluid device, such as gaseous and liquid devices. Since the injection materials used in the present invention are capable of forming a mechanical barrier, this barrier may also be capable of preventing gas to pass there through, depending on the injection material utilized.

Also, it is to be understood that the concepts of the present invention may be used in any application in which one or more benefits of the present invention may be utilized. For example, the tamper-resistant aspects of the present invention may be utilized in any application wherein it is desired to form a rigid connection between two or more components to prevent removal of one component from another. For example, there are many articles of manufacture wherein two components are secured to one another using an adhesive material. Nevertheless, the concepts of the present invention may use an injection material rather than an adhesive. In addition to providing better tamper-resistance, when the injection material has hardened, the material may also help make the device substantially fluid tight whereas the adhesive may not be capable of achieving this function.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. An improved fluid device comprising:
a housing;
a lid attached to the housing;
an inlet connector to the housing; and
an outlet connector from the housing;
wherein the fluid device includes at least one connection space between the housing and the lid, between the inlet connector and the housing, or between the outlet connector and the housing and wherein an injection material substantially fills at least one connection space between the housing and the lid, between the inlet connector and the housing, between the outlet connector and the housing, or a combination thereof.

2. The fluid device of claim 1, wherein the injection material is selected from thermoplastic elastomers, thermoplastic urethanes, styrene-ethylene-butylene-styrene elastomers, or a combination thereof.

3. The fluid device of claim 1, wherein at least one of the housing, the lid, the inlet connector and the outlet connector are constructed from a material selected from acrylonitrile-butadiene-styrene (ABS), polycarbonate, polycarbonate/ABS blend, a copolycarbonate-polyester, acrylic-styrene-acrylonitrile, acrylonitrile-(ethylene-polypropylene diamine modified)-styrene, phenylene ether resins, glass filled blends of polyphenylene oxide and polystyrene, blends of polyphenylene ether/polyamide, blends of polycarbonate/PET/PBT, polybutylene terephthalate and an impact modifier, polyamides, phenylene sulfide resins, polyvinyl chloride, high impact polystyrene, low/high density polyethylene, polypropylene and thermoplastic olefins, polyethylene and fiber composites, polypropylene and fiber composites, or combinations including at least one of these materials.

4. An improved fluid device comprising:
a housing;
an inlet connector to the housing; and
an outlet connector from the housing;
wherein the fluid device includes at least one connection space between the inlet connector and the housing or between the outlet connector and the housing and wherein an injection material substantially fills at least one connection space between the inlet connector and the housing or between the outlet connector and the housing or both.

5. The fluid device of claim 4, wherein the injection material is selected from thermoplastic elastomers, thermoplastic urethanes, styrene-ethylene-butylene-styrene elastomers, or a combination thereof.

6. The fluid device of claim 4, wherein at least one of the housing, the lid, the inlet connector and the outlet connector are constructed from a material selected from acrylonitrile-butadiene-styrene (ABS), polycarbonate, polycarbonate/ABS blend, a copolycarbonate-polyester, acrylic-styrene-acrylonitrile, acrylonitrile-(ethylene-polypropylene diamine modified)-styrene, phenylene ether resins, glass filled blends of polyphenylene oxide and polystyrene, blends of polyphenylene ether/polyamide, blends of polycarbonate/PET/PBT, polybutylene terephthalate and an impact modifier, polyamides, phenylene sulfide resins, polyvinyl chloride, high impact polystyrene, low/high density polyethylene, polypropylene and thermoplastic olefins, polyethylene and fiber composites, polypropylene and fiber composites, or combinations including at least one of these materials.

7. A method of making a fluid device comprising the steps of:
placing a fluid device into a low-pressure injection system wherein the fluid device comprises a housing, an inlet connector to the housing, and an outlet connector from the housing; wherein the fluid device includes at least one connection space between the inlet connector and the housing or between the outlet connector and the housing; and
injecting an injection material into at least one connection space between the inlet connector and the housing or between the outlet connector and the housing such that the injection material substantially fills at least one connection space between the inlet connector and the housing or between the outlet connector and the housing or both.

8. The method of claim 1, wherein the injection material is selected from thermoplastic elastomers, thermoplastic urethanes, styrene-ethylene-butylene-styrene elastomers, or a combination thereof.

9. The method of claim 1, wherein at least one of the housing, the lid, the inlet connector and the outlet connector are constructed from a material selected from acrylonitrile-butadiene-styrene (ABS), polycarbonate, polycarbonate/ABS blend, a copolycarbonate-polyester, acrylic-styrene-acrylonitrile, acrylonitrile-(ethylene-polypropylene diamine modified)-styrene, phenylene ether resins, glass filled blends of polyphenylene oxide and polystyrene, blends of polyphenylene ether/polyamide, blends of polycarbonate/PET/PBT, polybutylene terephthalate and an impact modifier, polyamides, phenylene sulfide resins, polyvinyl chloride, high impact polystyrene, low/high density polyethylene, polypropylene and thermoplastic olefins, polyethylene and fiber composites, polypropylene and fiber composites, or combinations including at least one of these materials.

10. The method of claim 7, wherein the fluid device further comprises a lid attached to the housing and wherein the fluid device includes at least one connection space between the housing and the lid and wherein the injection material is injected into at least one connection space between the housing and the lid such that the injection material substantially fills at least one connection space between the housing and the lid.
